(19) United States
(12) Patent Application Publication
(10) Pub. No.: US 2026/0008196 A1
(43) Pub. Date: Jan. 8, 2026

(54) Method for cutting closures for containers

(71) Applicant: SACMI COOPERATIVA MECCANICI IMOLA SOCIETA’ COOPERATIVA, Imola (IT)

(72) Inventors: Davide PENAZZI, Imola (IT); Matteo VENTURINI, Imola (IT); Ruggero MENZOLINI, Imola (IT)

(21) Appl. No.: 19/259,205

(22) Filed: Jul. 3, 2025

(30) Foreign Application Priority Data
Jul. 5, 2024 (IT) 102024000015628

(51) Int. Cl. B26D 1/00; B26D 5/20; B26D 7/06

(52) U.S. Cl. CPC B26D 1/0006; B26D 5/20; B26D 7/06; B26D 2001/0033; B26D 2001/004; B26D 2001/006

(57) ABSTRACT

Herein described is a cutting method for closure of the “tethered” type, wherein a spindle which carries a closure is moved towards a cutting device with one or more horizontal blades and at least one vertical or oblique blade. When cutting, the spindle rotates and the closure rolls on the cutting device. The spindle, which is fed several times to the cutting device each time carrying a different closure comprising a portion made of a material softer than the blades, therefore when cutting the blades penetrate into the closure material and therefore sink into the softer portion of the spindle. The spindle feed which carries the closure towards the cutting device is coordinated with the rotation of the spindle so that the vertical or oblique blade, each time the spindle is fed to the cutting device, always encounters the same area of the softer portion of the spindle. The method provides for a preliminary step in which the blades are moved in such a way as to gradually increase the depth with which they sink into the soft portion starting from an initial position distant from a nominal working position and reaching a final position in which the blades sink into the soft portion with a greater depth than the depth with which they sink when they are in the nominal working position.

### BACKGROUND OF THE INVENTION

The invention relates to a method for cutting closures or capsules which can be used for closing containers, such as for example bottles, in particular closures or capsules made of plastics.

Specifically, but not exclusively, the invention relates to a cutting apparatus and method suitable to obtain the device that is easy to open and with which there is provided for a closure or capsule of the type referred to as “tethered”, that is a closure or capsule which remains attached to the container after opening.

The prior art comprises methods for providing the facilitated opening device of a “tethered” capsule forming on the capsule one or more horizontal cuts and at least vertical or oblique cut, where “horizontal”, “vertical” and “oblique” refer to the capsule arranged with the geometric axis thereof vertical. Generally, the prior art methods provide for that the capsule is moved, along a cutting path with fixed blades, by a rotary spindle which supports the capsule, and which acts as an abutment element to reduce an effective cutting of the fixed blades.

The patent publication EP 4324761 A2 shows a cutting method according to the preamble of claim one. This method does not allow a significant decrease in the wear of the softer portion of the spindle due to the fact that the vertical or oblique blade penetrates into the softer portion of the spindle always in the same position, so that in the first strokes of the spindle the vertical or oblique blade will engrave a sort of vertical or oblique slot or groove in the material of the softer portion of the spindle and therefore, in the subsequent strokes, it will always interact with that slot or groove engraved previously, that is always in the same (linear) area, without further damaging the spindle.

Therefore, the method disclosed by EP 4324761 A2 allows to locate the wear of the soft part of the spindle only on a vertical or oblique area, without affecting other areas which may therefore remain whole and not worn for a long time therefore optimally carrying out the abutment function with respect to the closure during the cutting operation. The abutment function exerted by the spindle is particularly effective given that the vertical or oblique blade of the cutting device interferes only with an extremely limited area of the spindle, that is in the vertical or oblique linear area in the soft portion of the spindle into which the vertical or oblique blade sinks, leaving the remainder of the soft portion of the spindle intact and whole, especially the areas located in the immediate vicinity of the worn area and where the cutting is carried out. Therefore, being worn out and contiguous to the actual cutting area, such areas may act as an abutment element for cutting with maximum functions possible.

An improvable aspect of the prior art described above lies in the fact that it would be desirable to further reduce the interaction between the vertical or oblique blade and the material of the soft portion of the spindle.

### SUMMARY OF THE INVENTION

An object of the invention is to provide a method for cutting closures for containers capable of meeting the need mentioned above.

Another object is to provide a cutting method suitable for forming closures of the type referred to as “tethered”.

An advantage is to provide a cutting method capable of ensuring that, when cutting the capsules, the vertical or oblique blade does not touch against the bottom of the slot or groove engraved by the blade.

An advantage is to ensure that, when cutting the capsules, also the horizontal blade (or the horizontal blades, of there is more than one) does not touch against the bottom of the groove or circumferential slot engraved by the blade.

An advantage is to ensure the effectiveness and the quality of the cutting of the capsules for a long period of work, also in case of wear of one or more blades.

### BRIEF DESCRIPTION OF THE DRAWINGS

The invention will be clearer and better implemented with reference to the attached drawings which show an exemplifying and non-limiting embodiment thereof, wherein:

FIG. 1 is a vertical elevational section, of a part of an example of a cutting apparatus which can be used to implement a cutting method according to the present invention;

FIG. 2 is an enlargement of a detail of FIG. 1;

FIG. 3 is a top plan view of the apparatus of FIG. 1;

FIG. 4 is a top plan view of another example of a cutting apparatus which can be used to implement a cutting method according to the present invention;

FIG. 5 is an enlargement of a detail of FIG. 2 which shows the slot or groove engraved by the vertical or oblique blade to implement a cutting method according to the present invention.

### DETAILED DESCRIPTION

With reference to the figures mentioned above, an apparatus for cutting closures or capsules which can be used for closing containers, such as for example bottles, in particular closures or capsules made of plastics, has been indicated in their entirety with 1. The cutting apparatus 1 may in particular be suitable to obtain a device that is easy to open and with which there is provided for a closure or capsule of the type referred to as “tethered”, that is a closure or capsule which remains attached to the container after opening.

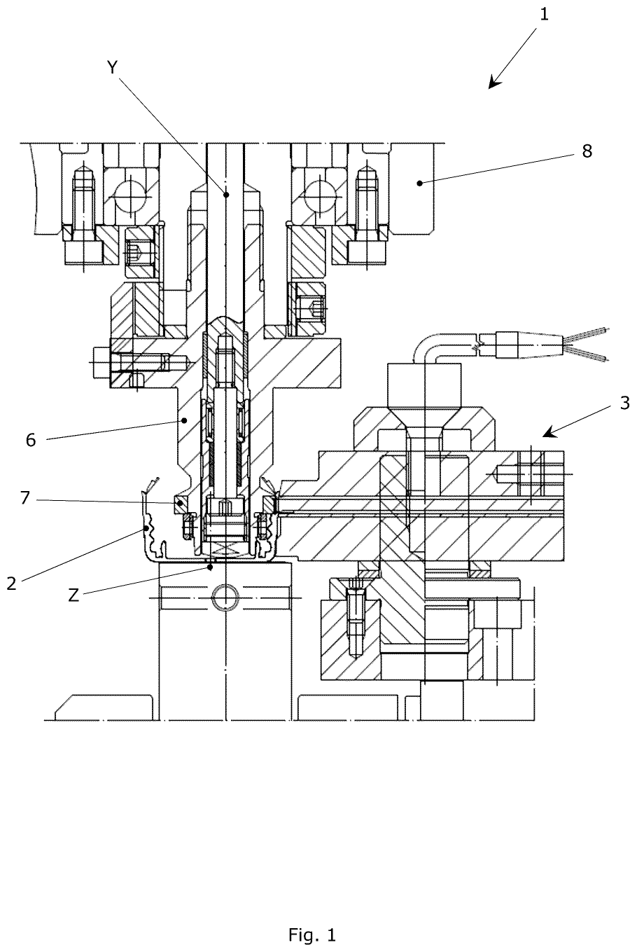

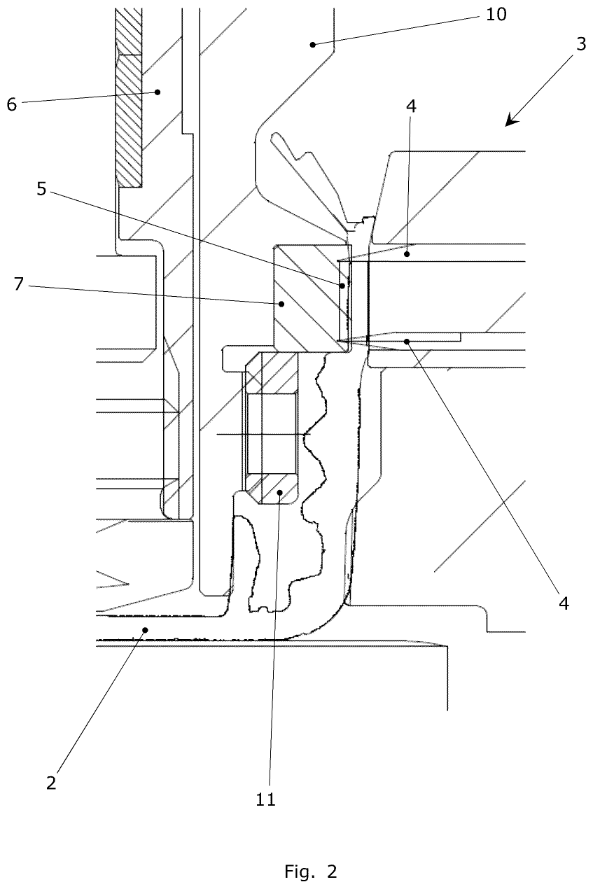

The cutting apparatus 1 may in particular comprise cutting means configured to obtain a facilitated opening device for a closure 2 of the “tethered” type. The cutting means may in particular comprise a cutting device 3 with one or more horizontal blades 4 and with at least one vertical or oblique blade 5. In the specific example, shown in FIGS. 1 and 2, the cutting device 3 comprises two horizontal blades 4 and a vertical blade 5.

The cutting means may in particular comprise a cutting device with a different number of horizontal blades, for example three or four or more, and with a different number of vertical or oblique blades, for example two or three or more.

The cutting device 3 may in particular be configured to selectively take an operative position, that is a position appropriate to carry out the desired through cuts on a closure fed to the cutting device 3, and an inoperative or receded position, in which the cutting device 3 is receded with respect to the working position so as not to interfere with a closure fed to the cutting device 3 and/or with a device for feeding the closure.

The displacements (for example linear displacements, in particular sliding on linear guides) of the cutting device 3 between the operative position and the receded inoperative position may be actuated manually and/or by drive means.

The cutting apparatus 1 may in particular comprise a feeding device configured to feed a closure 2 to the cutting means. The feeding device may in particular comprise at least one spindle 6 with a soft portion 7 made of a material softer than the blades.

The feeding device may in particular be configured so that the spindle 6 passes several times in front of the cutting means each time carrying a different 2 closure. The feeding device may in particular comprise a feeding carousel 8 which carries the spindle 6 mentioned above. The carousel 8 may in particular be rotatable (motor-driven, for example by a brushless motor) around a carousel axis X. The carousel 8 may in particular comprise two or more spindles 6, each of which may comprise a respective soft portion 7.

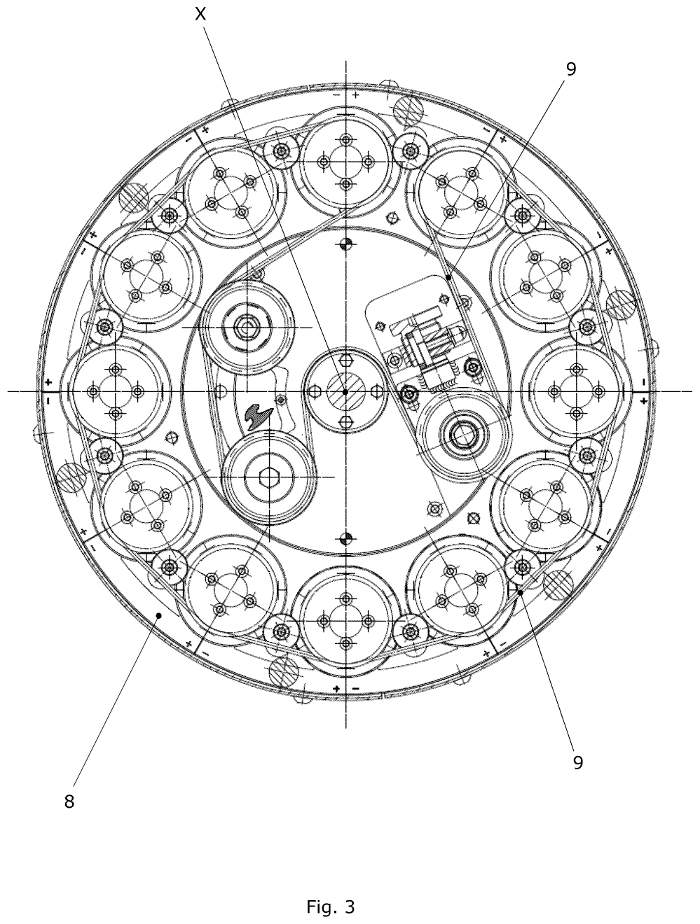

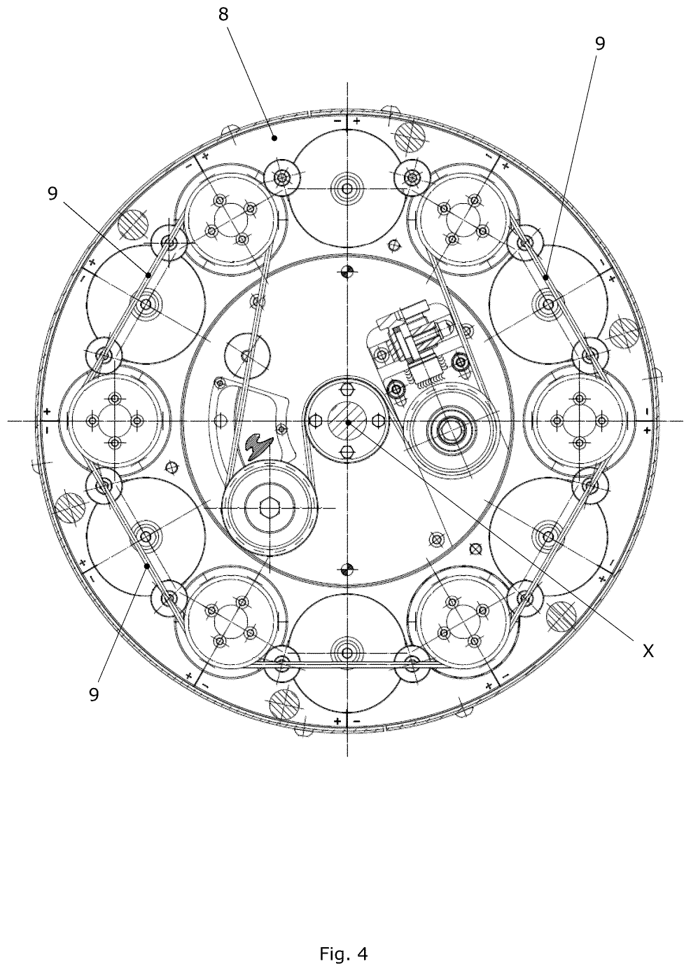

The carousel 8 may in particular comprise three or more spindles 6 arranged angularly spaced apart on a peripheral of the carousel. In the specific example of FIG. 3, the carousel comprises twelve spindles 6 which are equally spaced apart. In the specific example of FIG. 4, the carousel comprises six spindles 6 which are equally spaced apart.

Each spindle 6 may in particular be rotatable around a respective spindle axis Y and the closure 2 may move (for example, with an at least partly rolling movement) on the cutting means so that the blades 4 and 5 penetrate with a through cut into the closure 2 and therefore sink into the soft portion 7 of the spindle. The soft portion 7 acts as an appropriate and effective abutment for the side wall of the closure 2 during the cutting operation.

Each spindle 6 may in particular be rotatable around the spindle axis Y motor-driven by an actuation of a distinct motor (and which can be controlled independently, for example another brushless motor) with respect to the motor-driven actuation which actuates the rotation of the carousel 8, or by the same motor-driven actuation which actuates the rotation of the carousel 8.

The spindle axis Y may in particular be parallel to a geometric axis Z of the closure 2. The spindle axis Y may in particular be, like in this specific example, spaced apart from the geometric axis Z of the closure.

The cutting apparatus 1 may in particular comprise a controller configured to coordinate the rotation of the spindle 6 (around its spindle axis Y) with the feeding of the spindle 6 (that is the motion for advancement towards the cutting means, which in these examples comprises the rotation motion of the carousel 8 which carries the spindles 6) so that the vertical blade 5 (and/or the possible oblique blade), each time the spindle 6 passes in front of the cutting means, always encounters the same vertical or oblique (linear) area of the soft portion 7.

In particular, it may be provided for that the aforementioned coordination of movements (rotary motion of the spindle and advancement motion of the spindle) be obtained ensuring that the ratio between the number of revolutions in the time unit of the rotation axis of the carousel (axis X) and of the rotation axis of each spindle (axis Y) is equal to 1:N, where N is equal to an integer (for example a number comprised between 8 and 18, in particular a 1:12, or 1:13, or 1:14 ratio).

The cutting apparatus 1 may in particular comprise a mechanical drive system which connects the axis of the carousel (axis X) with the axis of each of the aforementioned spindles (axis Y). Such mechanical drive system may be built so as to obtain the aforementioned coordination of the movements in particular so as to obtain the aforementioned transmission ratio equal to 1:N, with N equal to an integer.

Such mechanical drive system may in particular comprise a transmission comprising at least one flexible transmission member 9 (coupled to pulleys connected to the spindles 6). However, there can be provided for other types of mechanical drive systems, for example of the gear type.

Furthermore, it may be provided for that the cutting apparatus comprises an electronic controller for controlling the coordinated motion of the axis of the carousel and of the axis of each of the aforementioned spindles in a synchronous manner, such as for example one or more electronic cams for coordinating the drive means for actuating the axis of the carousel with the drive means for actuating the axis of the spindles. In particular, it may be provided for that the means for actuating motors of the axis of the spindles comprises a plurality of motors, in particular a motor for each axis of the spindle, or a single motor connected to a plurality of spindle axes (for example, to all the spindle axes arranged on the carousel) by means of a mechanical drive system, for example a transmission as described above.

Each spindle 6 may in particular comprise a support body 10 with an annular seat open on one side. The soft portion 7 of the spindle may in particular comprise an annular insert which can be inserted (in particular, axially) into the aforementioned annular seat and through the aforementioned open side (wherein axially is understood with reference to the spindle axis).

Each spindle 6 may in particular comprise a locking annular element 11 which can be removably fixed (for example by means of a screw fixing deice) on the support body to close the aforementioned side of the annular seat, so as to keep the annular insert locked in position.

The operation of the cutting apparatus 1 implements the cutting method which may in particular comprise the step of feeding a spindle 6 which carries a closure 2 to a cutting device 3, wherein the cutting device 3 may comprise, as observed above, one or more horizontal blades 4 and at least one vertical or (oblique) blade 5.

The spindle 6 (for example driven in rotation by a carousel 8 along a circular advancement path) may be fed several times to the cutting device 3 each time carrying a different closure 2 (for example in a known manner, using a carousel 8 comprising an area for the input of closures to be cut and an area for the output of the cut closures).

Each spindle 6, as mentioned, may comprise a soft portion 7 (annular-shaped and coaxial with the spindle axis Y) made of a material softer than the blades. The soft portion 7 may be made of various materials, such as for example PEEK, Delrin®, polyethylene, polypropylene, polyurethane, aluminum, copper, tin, bronze, etcetera.

The cutting method may in particular comprise the step for rotating the spindle 6 around its spindle axis Y and move the closure 2 on the cutting device 3 so that the blades 4 and 5 penetrate into the closure and sink into the soft portion 7 of the spindle (see FIGS. 1 and 2).

The rotary motion of the spindle 6 may in particular be coordinated with the spindle 6 feeding motion so that the vertical or oblique blade, each time the spindle is fed to the cutting device, always encounters the same vertical or oblique (linear) area of the soft portion 7 the spindle.

To this end, for example it is possible to proceed in a manner such that the spindle is carried by a carousel 8 rotatable around a carousel axis X, and that the ratio between the number of revolutions in the time unit of the carousel X and of the spindle axis Y is equal to 1:N, with N equal to an integer.

By so doing, the vertical or (oblique) blade 5 will penetrates into the soft portion 7 of the spindle 6 still in the same position or area (in particular, a linear area whose geometry substantially corresponds to the geometry of the vertical or oblique blade 5), significantly reducing the wear of the soft portion 7, given that the first passages of the vertical or (oblique) blade 5 will engrave, in that position or zone on which the blade lies each time, a sort of (linear, vertical or oblique) slot or groove in the material of the softer portion of the spindle.

In the steps subsequent to the first, the vertical or (oblique) blade 5 will always interact with that position or zone where the (linear, vertical or oblique) slot or groove engraved previously was formed, without further damaging, in other zones, the soft portion of the spindle. Therefore, the soft portion 7 of the spindle may be worn in the initial step of the operation of the apparatus, during the first strokes of the spindle, in the aforementioned vertical or oblique area, that is with a wear circumscribed in a relatively very limited area of the overall circumference of the soft portion 7, after which it does not wear any more in other vertical or oblique areas.

It should be observed that the shape of the worn area of the soft portion may substantially correspond to the shape of the vertical or oblique blade-except for minimum dimensional differences due to possible elasticity and clearances of the system-leaving the remaining part of the material of the soft portion intact and whole, which may therefore carry out the abutment function with maximum efficacy, for an appropriate performance of the cutting operation, so that the facilitated opening device of the “tethered” closure will be built in an extremely precise and high-quality manner. The possible difference between the dimensions of the worn-out area of the soft portion and the dimensions of the vertical or oblique blade will be, as mentioned, the minimum difference possible, given that the shape and the dimensions of the worn-out area are generated by the interaction between the blade and the soft portion of the spindle.

The softer portion of the spindle will be worn out even in (circumferential) horizontal areas due to the horizontal blades 4 of the cutting device. The horizontal blades 4 will affect and always interact with the horizontal wear areas of the soft portion at each stroke of the spindle (that is at each revolution or a turn of the spindle-holder carousel).

It should be observed that, in the embodiment with a single mechanical drive system for actuating both the feeding motion and the rotation motion of the spindles, there is no need for the initial timing to prepare the cutting apparatus for timing the carousel axis of the spindle before starting the apparatus to cut the closures. As a matter of fact, it is not necessary that the rotary spindle 6 be in a precise angular position when it passes in front of the cutting device 3 (in particular, in front of the vertical or oblique blade 5) at the first stroke, that is at the initial start of the cutting apparatus 1, given that it does not matter which exactly is the area of the softer portion of the spindle that is affected, and therefore worn, by the vertical or oblique blade, given that it is sufficient that the spindle, from the second stroke onwards, passes in front of the cutting device in the same initial angular position of the first stroke, regardless of the initial angular position.

In the case of the versions with distinct drive means (one for actuating the spindle feeding motion, that is the rotation of the carousel, the other for actuating the rotation motion of each spindle arounds its axis), there can be carried out an initial timing, for example turning on and restarting the cutting apparatus 1, in a very simple manner, for example by receding the cutting device 3 (to avoid damaging the blades) and starting the drive means for a sort of initial “empty” calibration, for a short time required to allow the sensor (for example comprising an encoder) to recognize the angular position of the various spindles with respect to the carousel and therefore carry out appropriate adjustments to restore synchronization.

After this short initial timing step, the cutting device 3 may be once again advanced in the operative position to start the normal operation of the cutting apparatus. The recession of the cutting device 3 is not strictly indispensable, but it is however useful to avoid any wear or damage to the material of the soft portion 7.

However, it should be observed that, even in the event of no or inaccurate timing, the only result would be the contact of the blade with an area of the soft portion of the spindle not engraved previously, therefore without damaging the blade in any manner whatsoever (and with reduced additional wear of the soft portion), unlike the case, for example, of the solution disclosed in WO 2021/063776 A1, in which there would be a contact of the blade with a hard area of the spindle permanently damaging the blade.

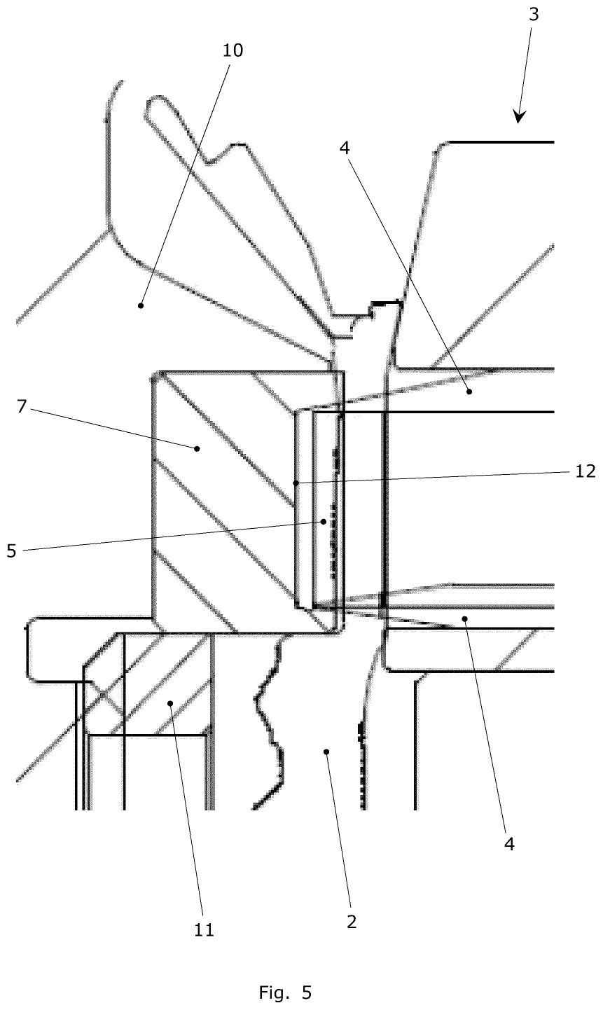

The cutting apparatus 1 may in particular comprise an anti-rotation device (not shown) configured to prevent a rotation of the soft portion 7 of the spindle with respect to the rest of the spindle, in particular to prevent rotations around the spindle axis Y. The anti-rotation device may in particular comprise the anti-rotation means 12 described in the patent publication EP 4324761 A2 (shown herein in FIGS. 5 to 8) herein incorporated for reference. By preventing the rotation of the soft portion 7 with respect to the rest of the spindle 6, the anti-rotation device guarantees that the area of the softer portion of the spindle that is affected, and therefore worn out, by the vertical or oblique blade, is always the same at each revolution of the carousel.

The cutting apparatus may be controlled by means of a control method suitable to reduce the risk of damaging the apparatus, in particular the blades 4, 5 of the cutting device 3. Such control method may in particular comprise a preliminary or initial start step (a sort of trial run), in which for a given period of time there is provided for an “empty” running of the spindles, that is in the absence of closures 2, that is with the rotation of the carousel and with the rotations of the spindles but without feeding the closures 2.

Such preliminary or trial run step provides for that each spindle 6 be fed several

times to the cutting device 3 without carrying the closure 2 (“empty”) and that during this “empty” feeding each blade (that is the horizontal blade/blades 4 and/or the vertical or oblique blade 5) be moved (forward, starting from an initial receded position distant from a nominal working position) so as to gradually increase the depth with which the blade sinks into the soft portion 7, in particular until it reaches, and then exceeds, the aforementioned nominal working position.

The expression “nominal working position” is used to indicate the position taken by the blade (each horizontal blade 4 and/or the vertical or oblique blade 5) in which the cutting edge of the blade sinks into the soft portion 7 with a desired depth during the actual cutting of the capsule 2.

According to the present invention, during the preliminary (trial run or initial start) step, each blade will sink into the soft portion 7 with a greater depth with respect to the depth corresponding to the nominal working position, so as to form a relatively deep slot or groove, that is in which the depth 12 of such slot or groove (FIG. 5) is spaced apart from the cutting edge of the blade when the actual cutting of the capsule 2 will be carried out. In other words, the bottom 12 is distant (deeper) with respect to the nominal working position.

FIG. 5 shows the bottom 12 of the slot or groove generated by the vertical or oblique blade 5 during the preliminary step. Due to the aforementioned preliminary trial run step, also each horizontal blade 4 will generate a respective slot or circumferential groove whose bottom will be distant (deeper) with respect to the nominal working position of the horizontal blade 4.

Basically, during this preliminary or initial start or trial run step, the cutting device 3 is initially controlled so as to take a receded configuration, that is in which the set of blades (one or more horizontal blades 4 and at least one vertical or oblique blade 5) is arranged in a receded position, where the expression “receded” is understood with reference to the pre-set nominal position and suitable to carry out the cutting of the closures 2. After which the set of blades is progressively moved forward in particular with a controlled graduality, in particular until it reaches and then exceeds (by a pre-established amount) the nominal cutting position.

During this progressive advancement, while the carousel continues to rotate and also the spindles continue to rotate (without carrying the closures 2), the blades of the cutting device 3 sink a little at a time increasingly into the soft portion 7 of the spindle 6, with a depth of penetration into the soft material of the spindles 6 that increases progressively, substantially at each revolution of the carousel for each spindle. The trend of the progression may be continuous or discontinuous or combined (partly continuous or partly discontinuous).

Such control method (progressive engraving cycle for the soft portions 7 of the spindles 6) may in particular be controlled by an operator through a specific control on the user interface.

Upon starting the progressive engraving cycle (trial run or initial start), it may be provided for (with the carousel inoperative) that the controller automatically recedes the blade assembly (which may in particular be in the nominal working position) by a given distance (for example, strictly by way of non-limiting example, by about 0.60 mm backwards with respect to the normal operative position of the blades).

After which, the controller automatically starts the rotation of the carousel and of the spindles carried by the carousel, starting a first step of slight engraving of the soft portions 7 of the various spindles 6. This first engraving step may have a pre-established programmed duration (for example, measuring about 2 minutes).

Subsequently, there may be provided for a second step of engraving the soft portions 7, slightly deeper than the previous one, advancing the blades by a pre-established amount, for example by approximately 0.05 mm. Therefore, the first advancement of the blades could for example be switching from the position −0.60 mm to the position −0.55 mm, taking reference zero as the actual or nominal working position which the blades are intended to take in the normal cutting condition of the closures 2.

This second engraving step may in particular comprise an initial interruption step in which the rotation of the carousel is interrupted, and therefore it may comprise the intermediate step for the controlled advancement of the blades, and a subsequent restart step, in which the controller automatically restarts the rotation of the carousel and of the spindles carried by the carousel, to actually start the actual step of engraving of the soft portions 7. Also this actual engraving step may have a pre-established programmed duration (for example, measuring about 2 minutes).

The aforementioned cycle for the interruption, advancement (for example by approximately 0.05 mm at each cycle) and restart may be automatically repeated until it reaches the actual nominal working position of the blades, that is the height value of the blades equal to 0.00 mm, at which the blades will cut the closures 2.

Subsequently, the second engraving step continues, further increasing the engraving depth of the soft portions 7 beyond the nominal working position, further advancing the blades by a pre-established amount, for example always about 0.05 mm. Therefore, the advancement of the blades (that is the increase in depth with which the blades sink into the soft material) may for example provide for switching from the position 0.00 mm to the position +0.05 mm, still taking reference zero as the actual or nominal working position that will be taken by the blades in the normal cutting condition of the closures 2.

The continuation of the second engraving step will end upon reaching a desired depth obtained by gradually advancing of the blades, for example up to the position +0.25 mm (value provided by way of non-limiting example).

The bottom 12 of the slot thus obtained will be at a pre-established distance from the actual or nominal working position of the blades in the cutting condition (the distance is intended as measured in the radial direction with respect to the spindle axis). In particular, such distance between the bottom 12 and the blades (in particular, the vertical or oblique blade 5) may be greater than or equal to 0.05 mm, or greater than or equal to 0.10 mm, or greater than or equal to 0.15 mm, or greater than or equal to 0.20 mm, or greater than or equal to 0.25 mm.

After the preliminary step mentioned above, each blade, in particular the vertical or oblique blade 5, starting from the above-mentioned final position of the preliminary step, is receded so as to position each blade in the nominal working position, after which the actual operating step and the actual cutting starts. Therefore, the closures 2 are fed and moved on the cutting device 3 and each blade, in particular the vertical or oblique blade 5, may penetrate into each closure 2 and sink into the soft portion 7 with the aforementioned desired depth.

FIG. 5 shows the blades in the actual and nominal working position (cutting the capsules), which clearly show the distance between the front cutting edge of the vertical or oblique blade 5 and the bottom 12 of the slot or groove which had been generated by the blades in the material of the soft portion 7 during the aforementioned preliminary step (initial trial run procedure) carried out before starting to cut the capsules. Such distance, combined with the fact that the vertical or oblique blade 5 encounters the soft portion 7 still in the same slot generation area, allows to significantly reduce the contact between the blade and the material of the soft portion.

The aforementioned values of the progressive advancement steps by 0.05 mm for each cycle and the engraving times of 2 minutes for each cycle are therefore values provided by way of examples and other values could be programmed (for example 0.01 mm, 0.02 mm, 0.03 mm, 0.04 mm, 0.06 mm, 0.07 mm, 0.08 mm, 0.09 mm, or 0.10 mm of progressive advancement for each cycle, and 1 minute, 1.5 minutes, 2.5 minutes or 3 minutes of engraving time for each cycle, in any possible progressive advancement combination and engraving times, even programming different progressive advancements and/or engraving times between one cycle (interruption, advancement, restart) and the other.

It should be observed that the aforementioned (radial) distance between the bottom 12 of the slot generated by the blades in the trial run step (in the absence of the capsules) and the blades in the actual operative configuration (that is cutting the capsules), allows to significantly reduce the risk of contact between the cutting edge of the blades and the aforementioned bottom 12 during each capsule cutting cycle.

This results in an overall decrease in the wear of the blades, given that, although the trial run or initial start step determines a relatively high cutting depth in the soft material, the almost total absence of the risk of contact of the blades with the bottom 12 in the actual work cycle, that is when cutting the capsules, is a significant advantage, which extensively compensates for the fact of sinking the blades deeper into the soft material when carrying out the preliminary trial run step.

Furthermore, it has been observed that the absence of the aforementioned contact, that is the contact between the cutting edge of the blades and the bottom of the slots obtained by the blades in the soft material (the vertical or oblique slot generated by the vertical or oblique blade 5 and the circumferential slots generated by the horizontal blades 4), with resulting decrease in the interaction between the cutting device and the soft portions 7 of the various spindles, ensures that the precision of the cutting of the capsules is maintained over time even after a high number of capsules cut.

The method may comprise the step for detecting a position of the cutting device 3, in particular a position of at least one of the horizontal blades 4 and/or a position of the vertical or oblique blade 5 and/or a position of a support block to which the horizontal blades 4 and the vertical or oblique blade 5 are fixed.

To this end, the cutting apparatus 1 may comprise a position sensor configured to detect the position mentioned above. The position sensor may in particular be arranged on the support block to which the horizontal blades 4 and the vertical or oblique blade 5 are fixed or on a fixed element of the cutting apparatus 1 arranged in proximity of the support block, so as to detect the relative position between the support block and the fixed element.

The position sensor is configured to emit signal indicating the detected position. Such signal is transmitted to the electronic controller of the cutting apparatus 1. The controller is configured to control the aforementioned position of the cutting device 3 (that is the position of at least one of the horizontal blades 4 and/or the position of the vertical or oblique blade 5 and/or the position of the support block to which the horizontal blades 4 and the vertical or oblique blade 5 are fixed) depending on the signals received from the position sensor.

The controller is configured to control the aforementioned position of the cutting device 3 as a function of one or more operating parameters of the cutting apparatus 1, for example of the overall work time in the service life of the apparatus.

The controller is configured to change the aforementioned position of the cutting device 3 even during the processing cycle of the cutting apparatus 1, so as to change the penetration of the horizontal blades 4 and of the vertical or oblique blade 5 based on a variation of at least one working condition. The expression “change the penetration” is used to indicate a change in the position of the cutting device 3 depending on which an increase in the penetration is obtained by means of an advancement of the blades of the cutting device 3 with respect to the spindle 6 while a decrease in the penetration is obtained by receding the blades.

In particular, the controller may be configured to increase the aforementioned penetration of the blades (that is a forward displacement of the cutting device 3 towards the spindle 6) as the wear degree of the blades increases. Such degree of wear may be checked by means of a sensor for monitoring the blades and/or by means of a sensor for monitoring the cutting carried out by the blades on the capsules and/or by means of an analysis carried out by an operator on the blades and/or on the capsules.

The increase in the penetration of the blades as the degree of wear increases allows to maintain high effectiveness and quality of cutting the capsules so as to compensate for the wear of the blades without having to replace them in advance.

In particular, the controller may be configured to feedback adjust the position (and therefore the penetration) of the blades as a function of a detected value of a temperature of the capsules, for example a temperature of the capsules before they are cut and/or a temperature of the capsules entering the cutting apparatus 1. In particular, it may be provided for that the control be programmed to increase the depth of penetration as the temperature of the capsules increases.

In particular, the controller may be configured to feedback adjust the aforementioned penetration of the blades into the capsule as a function of the material with which the capsules are made. For example, the controller may be configured to feedback adjust the aforementioned penetration of the blades into the capsule as a function of the percentage content of the PCR percentage content of recycled plastic material present in the material of the capsules. In particular, it may be provided for that the control be programmed to increase the penetration depth as the PCR percentage content decreases in the capsules, even if in some cases there may be provided for the reverse action (that is increase the penetration as the PCR content increases) depending on the type of material and/or the type of cut to be carried out and/or the type of capsule.

The information relating to the aforementioned PCR percentage content of recycled plastic material may be provided to the controller (for example by means of a user interface connected with the controller, or in any other manner) which as a result provides for controlling the cutting penetration of the blades into the capsule.

1. Cutting method for closures, said method comprising the steps of:
feeding a spindle which carries a closure to a cutting device, the spindle comprising a soft portion into which at least one blade of said cutting device can sink;
rotating the spindle to move the closure on the cutting device so that at least one vertical or oblique blade, positioned in a nominal working position, penetrates the closure and sinks into said soft portion with a desired depth;
coordinating the spindle rotation with the spindle feed so that the vertical or oblique blade, each time the spindle is fed to the cutting device, always encounters the same vertical or oblique area of said soft portion;
there being provided for a preliminary step in which the spindle is fed several times to the cutting device and in which, during said feeding in said preliminary step, said at least one vertical or oblique blade is moved in such a way as to gradually increase the depth with which it sinks into said soft portion starting from an initial position distant from said nominal working position and reaching a final position;
wherein, in said final position of said preliminary step, said at least one vertical or oblique blade sinks into said soft portion with a greater depth than the depth with which it sinks when it is in said nominal working position.

2. Method according to claim 1, wherein said preliminary step is performed without carrying the closure, that is “empty”.

3. Method according to claim 2, wherein said at least one vertical or oblique blade, starting from said final position of said preliminary step, is receded so as to reach said nominal working position, after which the closure is moved on said cutting device and said at least one vertical or oblique blade penetrates into the closure and sinks into said soft portion with said desired depth.

4. Method according to claim 1, wherein said vertical or oblique area of said soft portion is a linear area with a shape corresponding to a shape of said vertical or oblique blade.

5. Method according to claim 1, wherein, during said preliminary step, said at least one vertical or oblique blade generates a slot in said soft portion of the spindle, said slot having a bottom located at a distance greater than or equal to 0.05 mm from said at least one vertical or oblique blade in said nominal working position.

6. Method according to claim 1, wherein the spindle is carried by a carousel rotatable about a carousel axis, and wherein the ratio between the number of revolutions in the time unit of the carousel axis and the spindle axis is equal to 1:N, with N equal to an integer.

7. Method according to claim 1, wherein a carousel carries two or more spindles, each with a respective soft portion, said two or more spindles being driven in rotation around respective spindle axes by a single motor connected to said spindle axes by means of a mechanical drive system.

8. Method according to claim 1, wherein a carousel carries two or more spindles, each with a respective soft portion, and wherein a mechanical drive system connects a carousel axis with the axes of said two or more spindles.

9. Method according to claim 1, wherein a carousel carries two or more spindles, each with a respective soft portion, the rotation and feeding of each spindle being coordinated by means of a coordinated motion of a carousel axis and the axes of said two or more spindles controlled synchronously by an electronic controller.

10. Method according to claim 9, wherein said carousel is rotated by a drive system and each spindle axis is driven in rotation by its own drive motor distinct from the drive motors of the other spindle axes and distinct from said drive system of the carousel.

11. Method according to claim 1, comprising the step of arranging a device for preventing a rotation of said soft portion with respect to the rest of the spindle.

12. Method according to claim 1, wherein there is used cutting apparatus comprising:
said cutting device configured to obtain a facilitated opening device for a closure; and
a feeding device for feeding a closure to said cutting device, said feeding device comprising said spindle with said soft portion configured so that at least one blade of said cutting device penetrates the closure with a through cut and sinks into said soft portion of the spindle.

13. Method according to claim 12, wherein said cutting device comprises said at least one vertical or oblique blade to obtain a “tethered” type closure, said feeding device being configured so that the spindle passes several times in front of said cutting device, each time carrying a different closure, said apparatus comprising a controller configured to coordinate a rotation of the spindle with a spindle feeding motion to the cutting device so that said vertical or oblique blade, every time the spindle passes in front of the cutting device, always encounters the same vertical or oblique area of said soft portion, said controller being configured to control said preliminary step wherein said at least one vertical or oblique blade sinks into said soft portion with a depth greater than the depth with which it sinks when it is in said nominal working position.

14. Cutting method for closures, said method comprising the steps of:
feeding a spindle which carries a closure to a cutting device, the spindle comprising a soft portion into which at least one blade of said cutting device can sink;
rotating the spindle to move the closure on the cutting device so that at least one vertical or oblique blade, positioned in a nominal working position, penetrates the closure and sinks into said soft portion with a desired depth;
coordinating the spindle rotation with the spindle feed so that the vertical or oblique blade, each time the spindle is fed to the cutting device, always encounters the same vertical or oblique area of said soft portion;
detecting a position of said cutting device and controlling said position as a function of at least one operating parameter so as to modify a cutting penetration of said cutting device based on a variation of at least one operating condition.

15. Method according to claim 14, wherein said cutting penetration is modified as a function of a wear degree of said cutting device.

16. Method according to claim 14, wherein said cutting penetration is modified as a function of a temperature of the closure.

17. Method according to claim 14, wherein said cutting penetration is modified as a function of the material of which the closure is made.

18. Method according to claim 14, wherein said cutting penetration is modified as a function of a recycled plastic material content present in the material of the closure.

19. Method according to claim 14, wherein said cutting device comprises one or more horizontal blades and a support block to which said at least one vertical or oblique blade and said one or more horizontal blades are fixed, said position of said cutting device which is detected and controlled comprises a relative position of said support block with respect to a fixed element.
